(19) United States
(12) Patent Application Publication
(10) Pub. No.: US 2004/0219397 A1
(43) Pub. Date: Nov. 4, 2004

(54) Electrically isolated fuel cell powered server

(76) Inventors: Geoff M. Lyon, Menlo Park, CA (US); Cyril Brignone, Mignaloux (FR); Malena Mesarina, Mountain View, CA (US); Salil Pradhan, Santa Clara, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/425,902

(22) Filed: Apr. 29, 2003

(51) Int. Cl. H01M 8/00; H01M 8/04

(52) U.S. Cl. 429/12; 429/34; 429/22; 429/13

(57) ABSTRACT

An electrically isolated fuel cell powered server is disclosed. The present invention discloses: a server; an electrical module located within the server; a fuel cell, located within the server, for generating electrical power; and an electrical bus, located within the server, coupling the electrical power generated by the fuel cell to the electrical module. The method of the present invention discloses: generating electrical power for a server with a fuel cell located in the server; transmitting the electrical power from the fuel cell over an electrical bus, located in the server, to an electrical module, also located in the server; and adjusting the electrical power generated by the fuel cell in response to electrical power consumed by the electrical module.

### BACKGROUND OF THE INVENTION

1. Field of the Invention

The present invention relates generally to systems and methods for powering servers, and more particularly to an electrically isolated fuel cell powered server.

2. Discussion of Background Art

Modern service and utility based computing is increasingly driving enterprises toward consolidating large numbers of electrical servers, such as blade servers, and their supporting devices into massive data centers. A data center is generally defined as a room, or in some cases, an entire building or buildings, that houses numerous printed circuit (PC) board electronic systems arranged in a number of racks. Such centers, of perhaps fifty-thousand nodes or more, require that such servers be efficiently networked, powered, and cooled.

Typically such equipment is physically located within a large number of racks. Multiple racks are arranged into a row. The standard rack may be defined according to dimensions set by the Electronics Industry Association (EIA) for an enclosure: 78 in. (2 meters) wide, 24 in. (0.61 meter) wide and 30 in. (0.76 meter) deep.

Standard racks can be configured to house a number of PC boards, ranging from about forty (40) boards, with future configuration of racks being designed to accommodate up to eighty (80) boards. Within these racks are also network cables and power cables. FIGS. 1A through 1D each show an example of what such equipment racks can look like. FIG. 1A is a pictorial diagram of electrical cabling within a first equipment rack. FIG. 1B is a pictorial diagram of electrical cabling within a second equipment rack. FIG. 1C is a pictorial diagram of electrical cabling within a third equipment rack. And, FIG. 1D is a pictorial diagram of electrical cabling within a fourth equipment rack.

The PC boards typically include a number of components, e.g., processors, micro-controllers, high-speed video cards, memories, and semi-conductor devices, that dissipate relatively significant amounts of heat during the operation. For example, a typical PC board with multiple microprocessors may dissipate as much as 250 W of power. Consequently, a rack containing 40 PC boards of this type may dissipate approximately 10 KW of power.

Generally, the power used to remove heat generated by the components on each PC board is equal to about 10 percent of the power used for their operation. However, the power required to remove the heat dissipated by the same components configured into a multiple racks in a data center is generally greater and can be equal to about 50 percent of the power used for their operation. The difference in required power for dissipating the various heat loads between racks and data centers can be attributed to the additional thermodynamic work needed in the data center to cool the air. For example, racks typically use fans to move cooling air across the heat dissipating components for cooling. Data centers in turn often implement reverse power cycles to cool heated return air from the racks. This additional work associated with moving the cooling air through the data center and cooling equipment, consumes large amounts of energy and makes cooling large data centers difficult.

In practice, conventional data centers are cooled using one or more Computer Room Air Conditioning units, or CRACs. The typical compressor unit in the CRAC is powered using a minimum of about thirty (30) percent of the power required to sufficiently cool the data centers. The other components, e.g., condensers, air movers (fans), etc., typically require an additional twenty (20) percent of the required cooling capacity.

As an example, a high density data center with 100 racks, each rack having a maximum power dissipation of 10 KW, generally requires 1 MW of cooling capacity. Consequently, air conditioning units having the capacity to remove 1 MW of heat generally require a minimum of 300 KW to drive the input compressor power and additional power to drive the air moving devices (e.g., fans and blowers).

Quite clear from these Figures, technicians, who install and service these cable intensive racks, are presented with a substantial amount of work each time such electrical servers are installed, removed, or serviced. With such wiring complexity, not only do such tasks require a significant amount of time, to wade through all of the wires and cables, but there is also a substantial chance that errors will be made during reinstallation, especially if more than one server unit is serviced at a time. Such excessive cabling also impedes equipment inspection and substantially impedes the flow of cooling air within the equipment rack, leading to device hot-spots and thus premature equipment failure.

Another problem with conventional systems is that each equipment rack's power needs can vary substantially, depending upon: how many servers or other devices are located in the rack; whether such devices are in a standby mode or are being fully utilized; and the variations in rack cabling losses. While central high-voltage/current power sources located elsewhere in the data center can provide the necessary power, the aforementioned power consumptions variations often result in greater overall data center transmission line losses, and more power-line transients and spikes, especially as various rack equipment goes on-line and off-line. Due to such concerns, power-line conditioning and switching equipment is typically added to each rack, resulting in even greater losses and heat generation.

Reliance on central power systems also subjects the racks to data center wide power failure conditions, which can result in disruptions in service and loss of data. While some equipment racks may have a battery backup, such batteries are designed to preserve data and permit graceful server shutdown upon experiencing a power loss. The batteries are not designed or sized for permitting equipment within the rack to continue operating at full power though.

Each equipment rack's cooling needs can also vary substantially depending upon how many servers or other devices are located in the rack, and whether such devices are in a standby mode, or being fully utilized. Central air conditioning units located elsewhere in the data center provide the necessary cooling air, however, due to the physical processes of ducting the cooling air throughout the data center, a significant amount of energy is wasted just transmitting the cooling air from the central location to the equipment in the racks. Cabling and wires internal to the rack and under the data center floors blocks much of the cooling air, resulting in various hot-spots that can lead to premature equipment failure.

One way of reducing energy wasted by ducting cooling air from a central source to equipment within the racks is to directly cool various rack components using liquid cooling. Such systems include surrounding equipment with liquid cooled “cold-plates.” Such cold-plates may alternatively be mounted inside the equipment proximate to specific heat generating components. However, while such liquid cooling systems provide greater control and targeting of coolant to where it is needed most, such liquid systems also create a safety and reliability problem when interspersed with a rack's electrical cabling. Accidental spills, condensation, and/or leaky connections can easily damage or short-out various electrical equipment within the rack, resulting not only in degradation of the data center's level of service, but also a potentially very expensive repair bill.

In response to the concerns discussed above, what is needed is a system and method for powering servers that overcomes the problems of the prior art.

### SUMMARY OF THE INVENTION

The present invention is an electrically isolated fuel cell powered server. The present invention includes: a server; an electrical module located within the server; a fuel cell, located within the server, for generating electrical power; and an electrical bus, located within the server, coupling the electrical power generated by the fuel cell to the electrical module.

The method of the present invention includes: generating electrical power for a server with a fuel cell located in the server; transmitting the electrical power from the fuel cell over an electrical bus, located in the server, to an electrical module, also located in the server; and adjusting the electrical power generated by the fuel cell in response to electrical power consumed by the electrical module.

These and other aspects of the invention will be recognized by those skilled in the art upon review of the detailed description, drawings, and claims set forth below.

### BRIEF DESCRIPTION OF THE DRAWINGS

FIG. 1A is a pictorial diagram of electrical cabling within a first equipment rack;

FIG. 1B is a pictorial diagram of electrical cabling within a second equipment rack;

FIG. 1C is a pictorial diagram of electrical cabling within a third equipment rack;

FIG. 1D is a pictorial diagram of electrical cabling within a fourth equipment rack;

FIG. 2 is a block diagram of one embodiment of an electrically isolated fuel cell powered server; and

FIG. 3 is a flowchart of one embodiment of a method for controlling an electrically isolated fuel cell powered server.

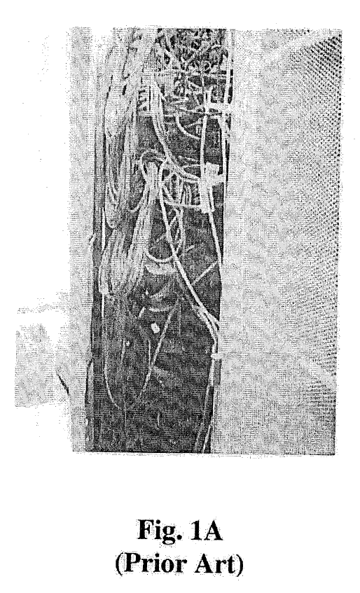

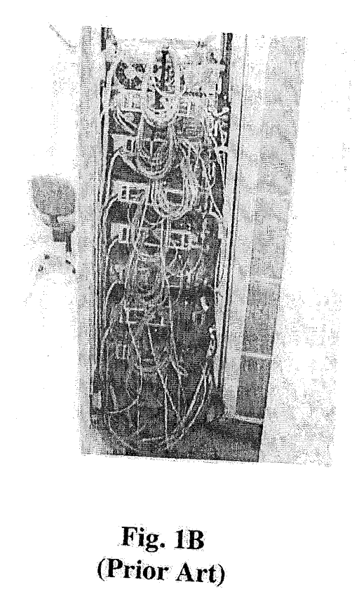

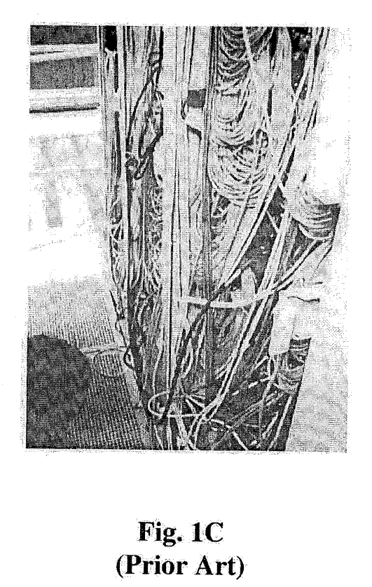

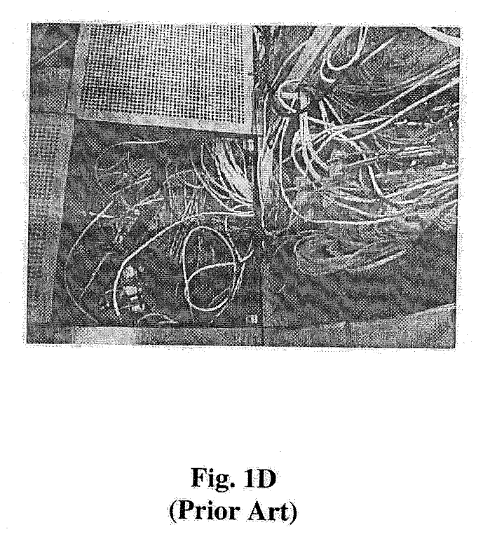

### DETAILED DESCRIPTION OF THE PREFERRED EMBODIMENT

The present invention in one embodiment uses fuel cell technology to reduce or eliminate reliance on a central power source by instantiating a fuel cell within a sealed server. The present invention significantly reduces or eliminates intra-rack power cabling, thereby permitting the rack to be more efficiently cooled, more easily serviced, and avoiding the problem of mixing rack fluids with rack electrical cabling. Fuel cell liquids, such as methanol, can also be used to help cool the server directly. All of these capabilities make the present invention particularly advantageous over the prior art.

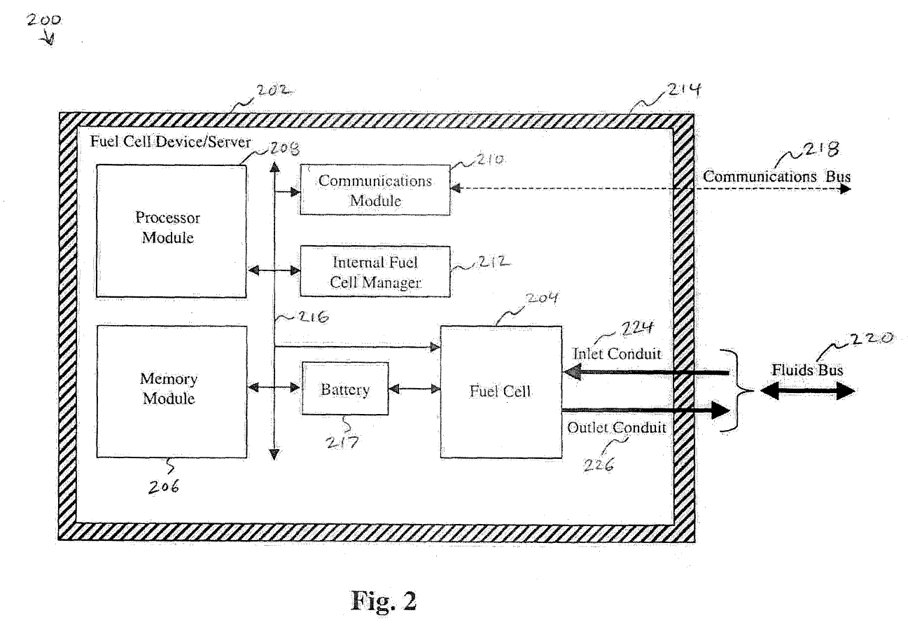

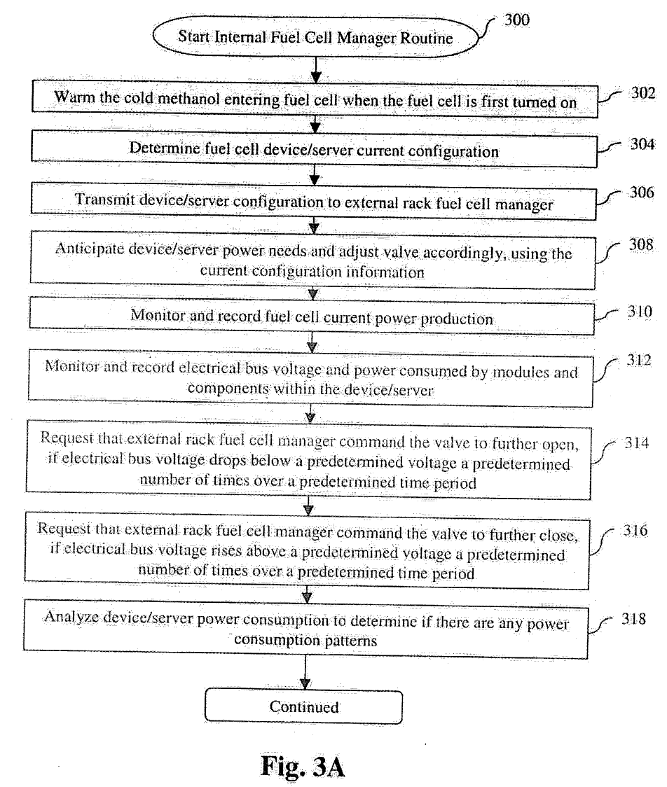

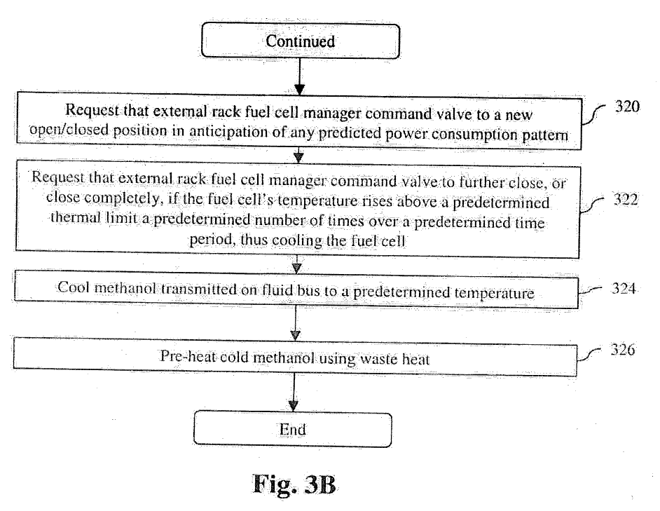

FIG. 2 is a block diagram of one embodiment 200 of an electrically isolated fuel cell powered device 202. FIG. 3 is a flowchart of one embodiment of a method 300 for controlling the electrically isolated fuel cell powered device 202. The device 202 and method 300 are herein described together in just one of many possible embodiments.

The fuel cell device 202 refers generally to any type of electrical device. More specifically, and preferably, the fuel cell device 202 is a fuel cell server. The fuel cell device/server 202, in the one embodiment discussed herein, is presumed to be located within an equipment rack (not shown) which itself is located within a data center (also not shown) of a predetermined size. The data center includes a variety of centralized resources, and stores. Those skilled in the art however will know that the fuel cell device/server 202 could alternatively be located in a variety of other environments. The fuel cell device/server 202 is also preferably a sealed unit which is electrically isolated from other external equipment.

The fuel cell device/server 202 in the one embodiment of the present invention, shown in FIG. 2, includes a fuel cell 204, a memory module 206, a processor module 208, a communications module 210, an internal fuel cell manager 212, and a thermally conductive external surface 214 (shown with diagonal lines). Those skilled in the art will recognize that the number of modules and other internal components in the fuel cell device 202 may be varied depending upon how the present invention is implemented.

The fuel cell 204 is preferably a Direct Methanol Fuel Cell (DMFC), although those skilled in the art recognize which other fuel cells may work as well. The fuel cell 204 includes a hydrogen circuit and an oxidizer circuit separated by a semi-permeable catalytic membrane. It is the interaction between the hydrogen and the oxidizer across the membrane which produces current flow and thus electrical power from the fuel cell 204. On the hydrogen circuit side of the membrane, a mixture of methanol and water enter into the fuel cell 204, while a mixture of methanol, water, and carbon dioxide exit. On the oxidizer circuit side of the membrane, an oxidizer, such as oxygen enters the fuel cell 204, while a mixture of oxygen, water, and nitrogen exit. The gasses exiting the oxidizer circuit are typically vented to the air, while the water is mixed back in with the water and methanol exiting the hydrogen circuit side of the membrane. Thus the fuel cell 204 typically requires at least two fluid ports, an input port for receiving the incoming methanol/water mixture and an output port for exhausting the outgoing methanol, carbon dioxide, and water mixture. During normal operation, the incoming fluid mixture is preferably very cold so that the methanol can be used to cool equipment within the rack 202. However, an added benefit of cold methanol is that the methanol's volatility is reduced.

The fuel cell 204 itself generates heat during its operation, and thus is preferably ensconced by the thermally conductive external surface 214, permitting said heat to be conducted to a cold plate or other cooling device. The memory module 206 and processor module 208 support internal device/server operations.

An electrical bus 216 internally routes electrical power generated by the fuel cell 204 to the other modules 206, 208 and 210 as well as to the internal fuel cell manager 212. A battery 217 is preferably connected between the fuel cell 204 and the electrical bus 216. The battery 217 helps provide a steady regulated voltage on the electrical bus 216 since the fuel cell's 204 output voltage is not easy to regulate. The internal fuel cell manager 212 preferably monitors the battery's 217 voltage as well as the battery's 217 charge rate from the fuel cell 204 and discharge rate from the electrical bus 216.

The communications module 210 is connected to a communications bus 218 routes data between the fuel cell device/server 202 and any external device, such as an external equipment rack fuel cell manager (not shown). Preferably the communications bus 218 is a fiber optic cable, so as to keep the fuel cell device/server 202 electrically isolated, and thus not be as affected by any fluid leaks external to the fuel cell device/server 202. However, the communications bus 220 could also be of another type.

A fluids bus 220, external to the fuel cell device 202, routes incoming and outgoing fluids to the fuel cell 204 from the data center's centralized fluid stores and repositories. Since the fuel cell 204 as discussed herein preferably is a methanol based fuel cell, the fluids bus 220 routes fluids to an methanol inlet conduit 224 and a methanol outlet conduit 226. The inlet conduit 224 and the output conduit 226 are preferably coupled to the fluid bus 220 using leak-resistant no-drip connectors.

A valve (not shown), which is external to the fuel cell device/server 202, controls the flow of methanol through the inlet conduit 224, in response to commands from the rack fuel cell manager. The valve has a range of adjustments from fully-open to fully-closed.

Since, the fuel cell 204 needs methanol in order to produce electricity, the more methanol available to the fuel cell 204, the more electricity the fuel cell 204 can produce, whereas, the less methanol made available to the fuel cell 204, the less electricity the fuel cell 204 can produce. By varying the amount of methanol supplied to the fuel cell 204 input port, the valve controls how much electricity the fuel cell 204 can produce, and functions similar to a conventional electrical power switch. Unlike electrical power switches, however, the valve does not consume electrical power and generate significant heat. Those skilled in the art will recognize that other embodiments of the present invention may use different fuel cell technology, which require a different, but functionally equivalent, fluid bus 220.

The internal fuel cell manager 212 is preferably a computer operated device which monitors and manages the fuel cell 204 and the fluid stream supplied via the fluid bus 220, according to the method 300 of FIG. 3. When the fuel cell 204 is first turned on, the internal fuel cell manager 212, in step 302, activates electrical heaters, powered by the internal battery, to warm the cold methanol entering the fuel cell 204 input port. Pre-heating the incoming methanol permits the fuel cell 204 to reach its normal operating efficiency level more quickly. Since the fuel cells themselves also generate heat during operation, such heat can be used to continue pre-heating the incoming methanol, so that the electrical heaters may be turned off.

In step 304, the internal fuel cell manager 212 determines the fuel cell device/server's 202 current configuration. The fuel cell device/server's 202 configuration refers to a number of power consuming modules and other components within the fuel cell device 202 and their individual power needs. The internal fuel cell manager 212 also calculates its own power consumption needs. In step 306, the internal fuel cell manager 212 transmits the device/server's 202 configuration to the external rack fuel cell manager (not shown) in the equipment rack which controls fluid bus 220 flow throughout the rack. In step 308, the external equipment rack fuel cell manager anticipates the device/server's 202 power needs and adjusts the valve accordingly, using the current configuration information.

In step 310, the internal fuel cell manager 212 monitors and records the fuel cell's 204 current power production. In step 312, the internal fuel cell manager 212 monitors and records the electrical bus 216 voltage and the power consumed by the modules 206, 208, 210 and other devices within the fuel cell device/server 202. If the electrical bus 216 voltage drops below a predetermined voltage a predetermined number of times over a predetermined time period, the internal fuel cell manager 212, in step 314, transmits a message over the communication bus 218 to the external equipment rack fuel cell manager, requesting that the rack fuel cell manager command the valve (not shown) to further open, thus permitting more methanol to flow to the fuel cell 204. Similarly, if the electrical bus 216 voltage rises above a predetermined voltage a predetermined number of times over a predetermined time period, the internal fuel cell manager 212, in step 316, transmits a message, over the communication bus 218 to the external equipment rack fuel cell manager, requesting that the rack fuel cell manager command the valve (not shown) to further close, thus restricting methanol flow to the fuel cell 204. Preferably the electrical bus 216 voltage is monitored at or near the battery 217 connected between the fuel cell 204 and the electrical bus 216. The battery is needed since the fuel cell's 204 output voltage is not easy to directly regulate.

In step 318, device/server 202 power consumption is analyzed by the internal fuel cell manager 212 to determine if there are any relatively predictable power consumption patterns. In step 320, the internal fuel cell manager 212 transmits a message, over the communication bus 218 to the external equipment rack fuel cell manager, requesting that the rack fuel cell manager command the valve to a new open/closed position in anticipation of the predicted power consumption pattern. Power consumption anticipation is preferred since fuel cells do not instantaneously vary their power output with changes in methanol flow.

If the fuel cell's 204 temperature rises above a predetermined thermal limit a predetermined number of times over a predetermined time period, the internal fuel cell manager 212, in step 322, transmits a message over the communication bus 218 to the external equipment rack fuel cell manager, requesting that the rack fuel cell manager command the valve to further close, or close completely, thus cooling the fuel cell 204.

While, as mentioned above, any type of fuel cell can power the fuel cell device/server 202, methanol fuel cells present certain further opportunities to cool the fuel cell device/server 202 as well. Methanol tends to be very volatile at room temperature, and can easily ignite or evaporate. Cooling the methanol, pumped to the fuel cell device 202, significantly reduces such volatility. However, methanol fuel cells also operate most efficiently when their incoming methanol stream is warmed/heated to a predetermined temperature. Such preferred engineering guides present an opportunity to both cool the fuel cell device 202 and pre-heat the methanol for the fuel cell 204 simultaneously. Thus in step 324, methanol transmitted on the fluid bus 220 is cooled to a predetermined temperature. Either as the methanol passes through the fluid bus 220, or is routed somewhere internal to the fuel cell device/server 202 itself, the cold methanol is pre-heated using waste heat, in step 326. Any pre-heating of the methanol preferably occurs after the methanol is used for cooling so that ability of the methanol to cool the rack equipment is maximized. Thus, within the present invention, power production and cooling are symbiotically combined, thereby further simplifying the rack's construction and ease of maintenance and operation.

While one or more embodiments of the present invention have been described, those skilled in the art will recognize that various modifications may be made. Variations upon and modifications to these embodiments are provided by the present invention, which is limited only by the following claims.

What is claimed is:

1. A system for supplying power, comprising:
a server;
an electrical module located within the server;
a fuel cell, located within the server, for generating electrical power; and
an electrical bus, located within the server, coupling the electrical power generated by the fuel cell to the electrical module.

2. The system of claim 1:
wherein the fuel cell uses methanol as fuel.

3. The system of claim 1:
further comprising, an equipment rack, having a fluid bus for carrying fuel cell fluids; and
wherein the server is a sealed server, located within the rack;
wherein the fuel cell is coupled to the fluid bus;
wherein the electrical bus is within the sealed server; and
wherein the fluid bus is external to the sealed server.

4. The system of claim 3, further comprising:
an external fuel cell manager, located external to the server, for controlling fluid flow on the fluid bus in response to requests to change fuel cell power generation; and
an internal fuel cell manager, located within the server and coupled to the fuel cell and the electronic module, for transmitting requests, to the external fuel cell manager, to change fuel cell power generation.

5. The system of claim 4, further comprising:
a valve, for varying fluid flow on the fluid bus, in response to commands from the external fuel cell manager.

6. The system of claim 4, further comprising:
a communications bus, coupling the internal fuel cell manager to the external fuel cell manager.

7. The system of claim 6:
wherein the communications bus includes a fiber optic cable.

8. The system of claim 1:
further comprising a battery coupled to the electrical bus, for sourcing and sinking electrical power.

9. The system of claim 1:
wherein the server includes a thermally conductive external surface.

10. A system for supplying power, comprising:
a server;
an electrical module located within the server;
a fuel cell, located within the server, for generating electrical power;
an electrical bus, located within the server, coupling the electrical power generated by the fuel cell to the electrical module;
an equipment rack, having a fluid bus for carrying fuel cell fluids;
an external fuel cell manager, located external to the server, for controlling fluid flow on the fluid bus, in response to requests to change fuel cell power generation;
an internal fuel cell manager, located within the server and coupled to the fuel cell and the electronic module, for transmitting requests, to the external fuel cell manager, to change fuel cell power generation; and
a valve, for varying fluid flow on the fluid bus, in response to commands from the external fuel cell manager.

11. A method for supplying power, comprising:
generating electrical power for a server with a fuel cell located in the server;
transmitting the electrical power from the fuel cell over an electrical bus, located in the server, to an electrical module, also located in the server; and
adjusting the electrical power generated by the fuel cell in response to electrical power consumed by the electrical module.

12. The method of claim 11, wherein generating includes:
generating electrical power with a methanol fuel cell.

13. The method of claim 11, wherein adjusting includes:
sending a message from an internal fuel cell manager, located within the server, to an external fuel cell manager, located external to the server, requesting more fuel to flow to the fuel cell, if more electrical power is consumed by the electrical module than is generated by the fuel cell.

14. The method of claim 11, wherein adjusting includes:
sending a message from an internal fuel cell manager, located within the server, to an external fuel cell manager, located external to the server, requesting that fuel flow to the fuel cell be restricted, if less electrical power is consumed by the electrical module than is generated by the fuel cell.

15. The method of claim 11:
further comprising, predicting future electrical power consumption by the electrical module based on past power consumption patterns of the electrical module; and
wherein adjusting includes adjusting the electrical power generated by the fuel cell in anticipation of the predicted future electrical power consumption.

16. The method of claim 11 further comprising:
restricting fuel flow to the fuel cell, if a temperature of the fuel cell rises above a predetermined thermal limit.

17. The method of claim 11:
further comprising, electrically isolating the electrical bus from all electrical power supplies external to the server.

18. A system for supplying power, comprising a:
means for generating electrical power for a server with a fuel cell located in the server;
means for transmitting the electrical power from the fuel cell over an electrical bus, located in the server, to an electrical module, also located in the server; and
means for adjusting the electrical power generated by the fuel cell in response to electrical power consumed by the electrical module.
